(19) United States
(12) Patent Application Publication
(10) Pub. No.: US 2016/0129765 A1
(43) Pub. Date: May 12, 2016

(54) BARRIER APPARATUS

(71) Applicant: Carlito C. Taad, N. Las Vegas, NV (US)

(72) Inventor: Carlito C. Taad, N. Las Vegas, NV (US)

(21) Appl. No.: 14/536,906

(22) Filed: Nov. 10, 2014

(51) Int. Cl. B60J 1/20

(52) U.S. Cl. CPC B60J 1/2063; B60J 1/2036; B60J 1/2019; B60J 1/2016

(57) ABSTRACT

A barrier apparatus partially covers a window in a vehicle. A panel extends and retracts at a parallel spacing to the window. The panel provides shade against light passing through the window. The panel retracts and extends to the shape and width of the window. The panel can be rolled and stored in a storage portion above the window frames, within a ceiling region of the vehicle. The panel includes a first end that joins with the storage portion. A slit in the ceiling enables at least partial passage of the panel during retraction and extension. A second end of the panel is tapered to restrict passage through the slit. A telescoping rod joins the panel with a track that aligns with the window edges. The length of the telescoping rod adjusts relative to the width of the window so the panel contours the window edges.

### CROSS-REFERENCE TO RELATED APPLICATIONS

No applicable.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to a barrier apparatus. More particularly, the invention relates to a barrier apparatus that extends and retracts along a window and at the same width of the window to provide shade.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a sun visor is a component of a vehicle located on the interior just above the windshield. The sun visor is designed with a hinged flap that is adjustable to help shade the eyes of drivers and passengers from the glare of sunlight. The sun visor can also block some of the heating effects of the sun beating down in the vehicle.

Often, a cardboard sunshade can be positioned on the front windshield of the vehicle. This front windshield shade can help reduce the heat on the front portion of the vehicle. The shade prevents the front dashboard and portions of the front seat from being exposed directly to the sun. The cardboard could also be placed in the rear window.

It is known that during hot durations, it is quite common for the interior of a vehicle to become uncomfortably hot. Many times, the interior of a vehicle becomes so hot, that it is painful to touch various parts of the vehicle. In addition, any personal items stowed within the interior of the vehicle are susceptible to damage from excessive heat. Also, privacy may be needed inside a vehicle. Tinted windows can be used to increase the shading to such a degree that vision is restricted through the windows.

In one example, when the outdoor temperature reaches 95° Fahrenheit, the air temperature inside of a car can reach 120° in just twenty minutes. The steering wheel hits 159° to the touch, the seat reaches 162° and the dashboard of the vehicle, which receives more direct sunlight and UV rays than any other interior component, gets the hottest—181°. This heat can be reduced by restricting passage of sunlight into the car.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A and 1B illustrate detailed perspective views of an exemplary vehicle shaded and unshaded by an exemplary barrier apparatus, where FIG. 1A illustrates an exemplary panel fully retracted, and FIG. 1B illustrates the panel fully extended across at least one window, in accordance with an embodiment of the present invention;

FIG. 2 illustrates a detailed perspective view of an exemplary barrier apparatus with the panel fully extended and following an exemplary track, in accordance with an embodiment of the present invention;

FIGS. 3A and 3B illustrate detailed perspective views of an exemplary telescoping rod engaged with the track, where FIG. 3A illustrates the track integrated into the vehicle, and FIG. 3B illustrates an exemplary roller traversing an exemplary channel in the track, in accordance with an embodiment of the present invention;

FIGS. 4A and 4B illustrate close up views of an exemplary telescoping rod adjusting in length, where FIG. 4A illustrates the telescoping rod shortened to compensate for a higher point along the window, and FIG. 4B illustrates the telescoping rod lengthened to compensate with a lower point along the window, in accordance with an embodiment of the present invention;

FIG. 5 illustrates a side perspective view of an exemplary barrier apparatus with the panel partially extended and following an exemplary track, in accordance with an embodiment of the present invention;

FIG. 6 illustrates a sectioned view of an exemplary storage portion having an exemplary motor for automating the retraction and extension of the panel, in accordance with an embodiment of the present invention; and

FIG. 7 illustrates a detailed perspective view of an exemplary control portion for controlling the retraction and extension of the panel from an interior region of the vehicle, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

There are various types of barriers for shading an interior region of a vehicle that may be provided by preferred embodiments of the present invention. In one embodiment of the present invention, a barrier apparatus may at least partially shade at least one window in a vehicle. In some embodiment, the apparatus may integrate into the vehicle, such as to provide a barrier for shading an interior region of the vehicle. The at least one window may include, without limitation, a vehicle window, including the four side windows, the windshield, and the rear window of the vehicle. The apparatus may join either on the exterior or the interior of the vehicle. In some embodiment, the apparatus may integrate into the vehicle, such that the barrier does not have to be repetitively removed for each use.

In some embodiments, the apparatus may include a panel that extends and retracts at a parallel spacing to the window. The panel at least partially restricts the passage of light while positioned adjacently to the window. Additionally, the panel may be tinted and may include a mesh composition to provide additional protection from the sun, and also provide privacy. The panel follows an actuation path along a longitudinal length of the window. The panel retracts and extends to the shape of the window, namely in respect to the width dimensions and/or in respect to the curvature of the window. In some embodiments, the panel may extend and retract automatically to a desired position relative to the window for providing a desired amount of shade; whereby each window may be shaded independently of the other windows. In some embodiments, the panel may be affixed above a window frame for each window. The panel may be rolled and stored above the window frames, within a ceiling region of the vehicle when not in use.

The panel may include a first end disposed to join with a storage portion located above the window frames of the vehicle. In one embodiment, the storage portion may be hidden above the ceiling region in the vehicle. A slit in the ceiling region aligns with the storage portion to enable at least partial passage of the panel during retraction and extension. In some embodiments, the storage portion may include a cylinder disposed to receive the first end of the panel. The cylinder may be configured to rotate in a first direction for retracting the panel, and rotate in a second direction for extending the panel. In one embodiment, the storage portion may include a motor for automating the extension and retraction of the panel. In some embodiments, the panel may include a second end that terminates at a tapered portion. The tapered portion may have a substantially tear drop shape that restricts the second end from entering into the storage portion during retraction. The panel may also include a pair of lateral ends that generally conform to the tapered width of the window.

In some embodiments, a telescoping rod may extend from one of the lateral ends of the panel. The telescoping rod extends out to join with a track that traverses the length of the window. The telescoping rod extends out to join with a track that traverses the length of the window. The telescoping rod may help the panel move up and down at a corresponding angle as the respective window. In some embodiments, the telescoping rod may include a panel end that joins with one of the lateral ends of the panel. In one embodiment, the cavity in the tapered portion receives the panel end of the telescoping rod.

In one embodiment, the track extends from the ceiling region to a floor region of the vehicle. In another embodiment, the track may be integrated into the vehicle, such as along a vehicle door frame. The track may include a channel configured to receive a track end of the telescoping rod. The track may help guide the telescoping rod along an actuation path along the window, in alignment with the window edges. The telescoping rod may be configured to adjustably increase and decrease in length in conformance with the width of the window.

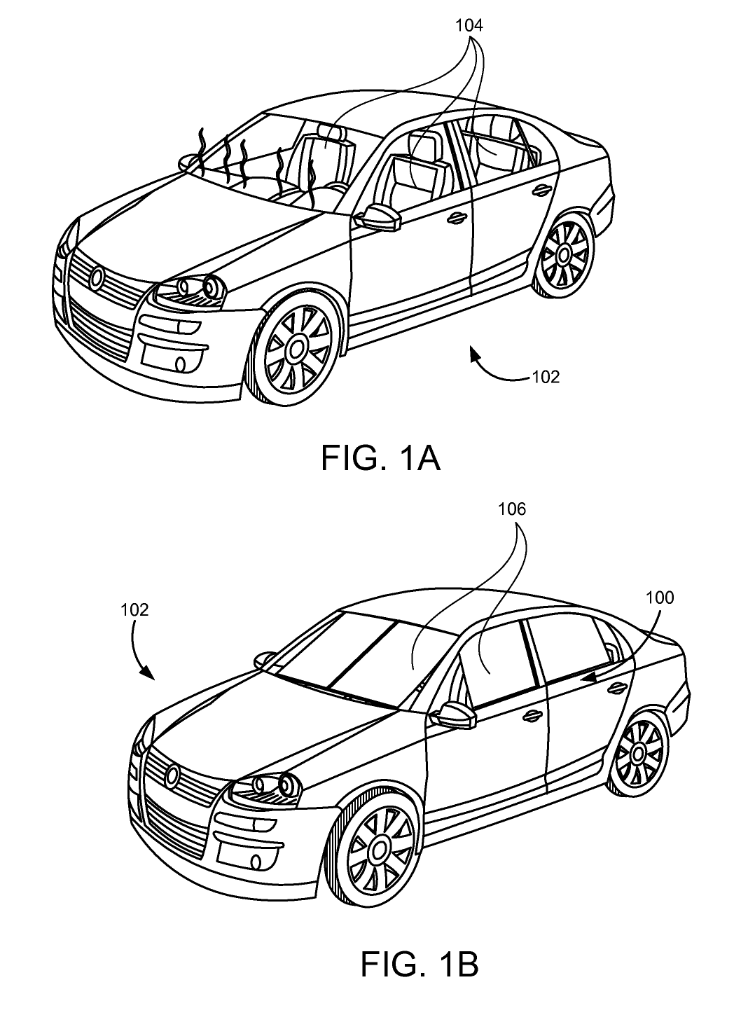

FIGS. 1A and 1B illustrate detailed perspective views of an exemplary vehicle shaded and unshaded by an exemplary barrier apparatus, where FIG. 1A illustrates an exemplary panel fully retracted, and FIG. 1B illustrates the panel fully extended across at least one window, in accordance with an embodiment of the present invention. In the present invention, a barrier apparatus 100 may at least partially form a protective barrier for shading at least one window 104 of a vehicle 102. The apparatus may also provide privacy in the interior region of the vehicle. In some embodiment, the apparatus may integrate into the vehicle, such that the barrier does not have to be repetitively removed for each use.

In one embodiment, the apparatus may include a panel 106 disposed to position in a parallel spacing from the window. The panel forms a protective shade from the sun in a passenger compartment of the vehicle. The at least one window may include, without limitation, a vehicle window, including the four side windows, the windshield, and the rear window of the vehicle. The apparatus may join either on the exterior or the interior of the vehicle. However, in some embodiments, the apparatus is positioned inside the vehicle. In some embodiments, the barrier apparatus may be secured near or within the frame structure of various types of windows, including, without limitation, household windows and sliding glass doors.

For example, without limitation, the panel shades an entire windshield, so to block the vicious sunlight. The panel can also shade side windows in the vehicle, so it blocks that light from other angles. The panel may even block sunlight passing through the rear window, so there's no blinding reflection in the rearview mirror. The panel is translucent. The panel is retractable, so at any point. And in one embodiment, the panel is automatically retractable and motorized, controlled by a control portion having buttons and switches.

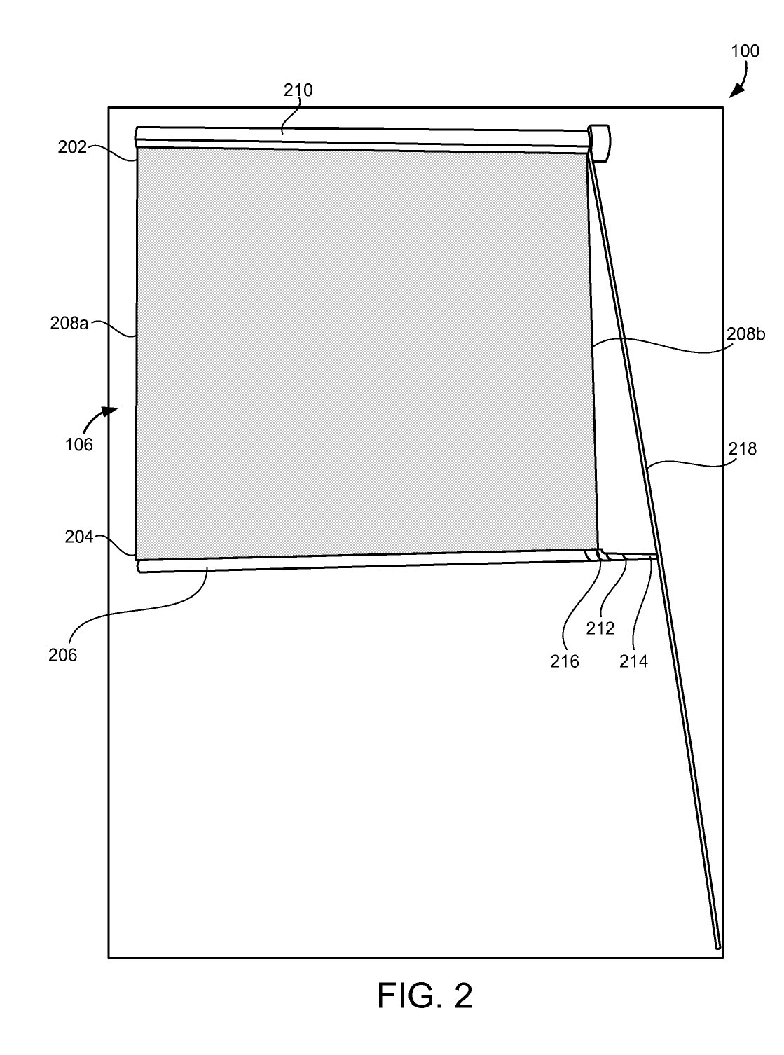

FIG. 2 illustrates a detailed perspective view of an exemplary barrier apparatus with the panel fully extended and following an exemplary track, in accordance with an embodiment of the present invention. In the present invention, the apparatus may include a panel that extends and retracts at a parallel spacing to the window. In some embodiments, the panel may be configured to provide at least partial shade against light passing through the at least one window. In some embodiments, the panel at least partially restricts the passage of light while positioned adjacently to the window. Suitable materials for the panel may include, without limitation, mesh, a polymer, a nonwoven material, ethylene tetrafluoroethylene (ETFE), polyvinyl chloride acetate (PVCA), vinyl-rubber and an animal skin. The panel may be tinted sufficiently dark as to provide a partial visual barrier to the window. The tint may include a 35% visible light transmission rating.

In some embodiments, the panel follows an actuation path along the window for providing the desired amount of shade. In some embodiments, the panel may be configured during retraction and extension to the shape of the window, namely in respect to the width dimensions and/or in respect to the curvature of the window. The panel extends and retracts automatically to a desired position relative to the window for providing a desired amount of shade; whereby each window may be shaded independently of the other windows. In some embodiments, the panel may be affixed above a window frame for each window. The panel may be rolled and stored above the window frames, within a ceiling region of the vehicle when not in use. The panel may even be extended and retracted horizontally.

The panel may include a first end 202 disposed to join with a storage portion 210 located above the window frames of the vehicle. In one embodiment, the storage portion may be hidden above a ceiling region in the vehicle. A slit in the ceiling region aligns with the storage portion to enable at least partial passage of the panel during retraction and extension. In some embodiments, the storage portion may include a cylinder disposed to receive the first end of the panel. The cylinder may be configured to rotate in a first direction for retracting the panel, and rotate in a second direction for extending the panel.

In one embodiment, the storage portion may include a motor for automating the extension and retraction of the panel. In some embodiments, the panel may include a second end 204 that terminates at a tapered portion 206. The tapered portion may have a substantially tear drop shape that restricts the second end from entering into the storage portion during retraction. The tapered portion comprises a cavity. The panel may also include a pair of lateral ends 208a, 208b that generally conform to the tapered width of the window. The panel can come in any shape that will allow it to function such as but not limited to oval, square, pentagonal, hexagonal, rectangular, and triangular.

In some embodiments, a telescoping rod 212 may extend from one of the lateral ends of the panel. The telescoping rod extends out to join with a track that traverses the length of the window. Those skilled in the art will recognize that a windshield and back glass are not completely vertical and are placed at an angle. The telescoping rod may help the panel traverse up and down at a corresponding angle as the respective window. In some embodiments, the telescoping rod may include a panel end 216 that joins with one of the lateral ends of the panel. In one embodiment, the cavity in the tapered portion receives the panel end of the telescoping rod. In one embodiment, the cavity forms about 25% of the area of the tapered portion. The telescoping rod extends perpendicularly from the second end of the panel. In one embodiment, the telescoping rod extends perpendicularly from the second end of the panel.

The telescoping rod may further include a track end 214. The track end joins with a track 218. The track may include a rigid, linear member. The track helps guide the panel in at least partial alignment with the window. The track may include a linear rod that also forms a support structure for the telescoping rod. In one embodiment, the track extends from the ceiling region to a floor region of the vehicle. In another embodiment, the track may be integrated into the vehicle, such as along a vehicle door frame.

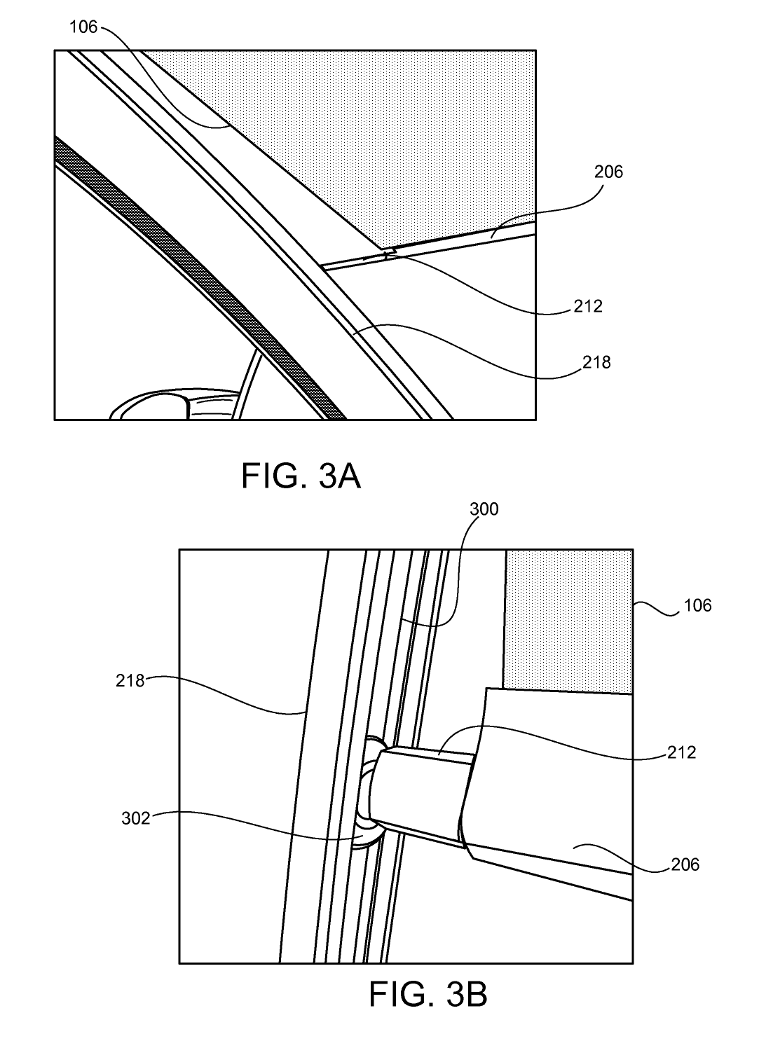

FIGS. 3A and 3B illustrate detailed perspective views of an exemplary telescoping rod engaged with the track, where FIG. 3A illustrates the track integrated into the vehicle, and FIG. 3B illustrates an exemplary roller traversing an exemplary channel in the track, in accordance with an embodiment of the present invention. In the present invention, the track end of the telescoping rod may include a roller 302 that rolls along the channel in the track. The roller may include, without limitation, a plastic wheel, ball bearings, and smooth rails. The track may include a channel 300 configured to receive the roller. In one embodiment, the roller is configured to roll inside the channel for creating a smoother actuation path for the panel to follow. The track may help guide the telescoping rod along an actuation path along the window, in alignment with the window edges. The telescoping rod may be configured to adjustably increase and decrease in length in conformance with the width of the window.

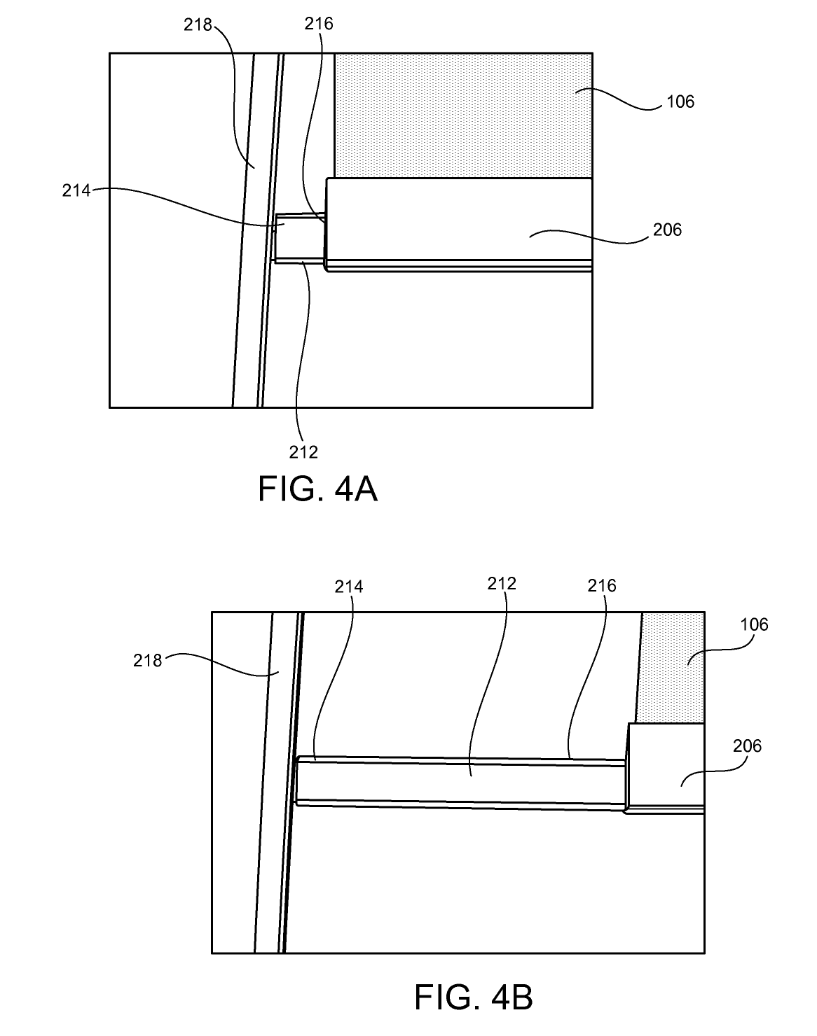

FIGS. 4A and 4B illustrate close up views of an exemplary telescoping rod adjusting in length, where FIG. 4A illustrates the telescoping rod shortened to compensate for a higher point along the window, and FIG. 4B illustrates the telescoping rod lengthened to compensate with a lower point along the window, in accordance with an embodiment of the present invention. In the present invention, the telescoping rod may adjust in length through a spring biased mechanism. Those skilled in the art will recognize that the adjustable length of the telescoping rod is needed because windows, and especially vehicle windows, are usually wider at their lower points than their top points. For example, as the panel is retracted lower along the window, the telescoping rod increases in length to compensate for the wider range of the window.

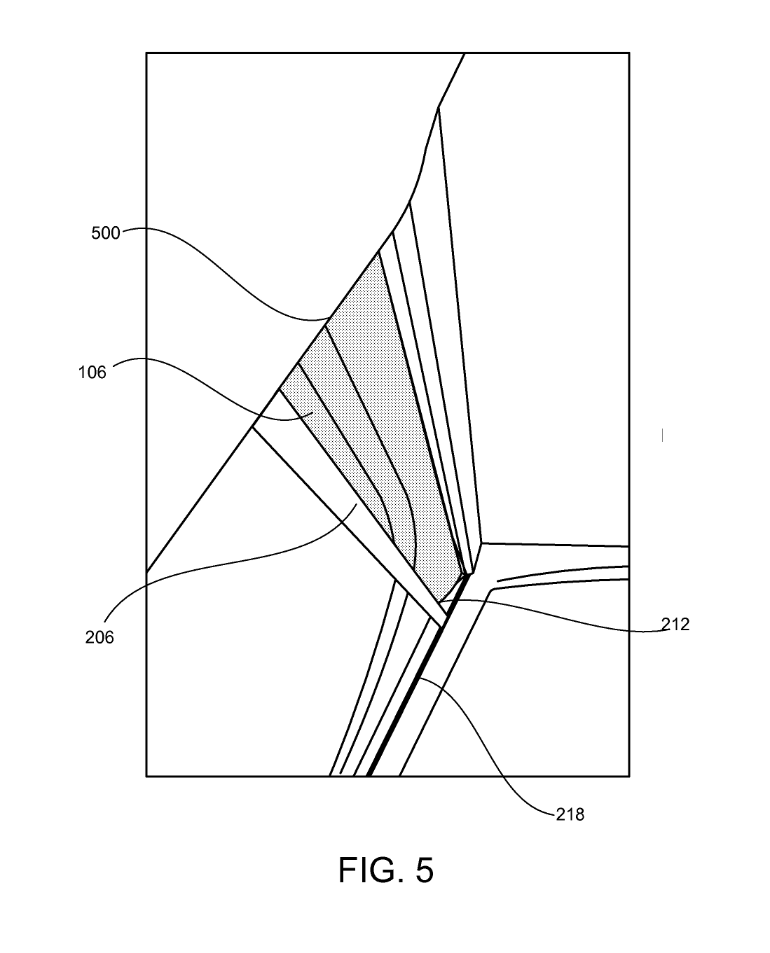

FIG. 5 illustrates a side perspective view of an exemplary barrier apparatus with the panel partially extended and following an exemplary track, in accordance with an embodiment of the present invention. In the present invention, the panel follows an actuation path along a window frame 500 for providing the desired amount of shade. The panel extends and retracts automatically to a desired position relative to the window for providing a desired amount of shade; whereby each window may be shaded independently of the other windows. In some embodiments, the panel may be affixed above the window frame for each window. The panel may be rolled and stored above the window frames, within a ceiling region of the vehicle when not in use.

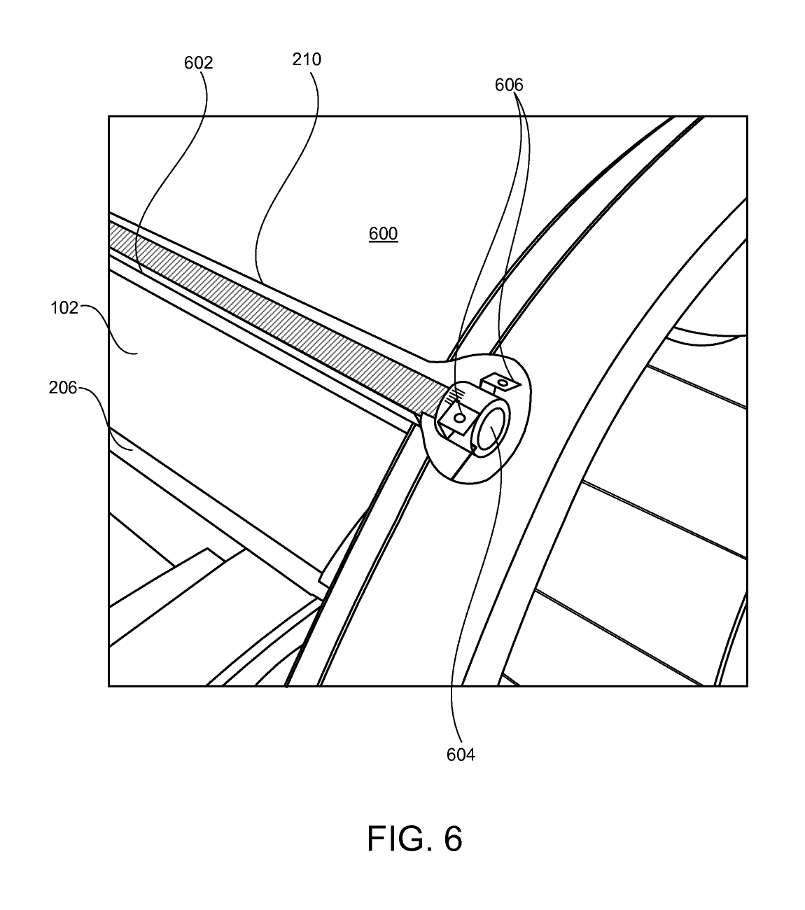

FIG. 6 illustrates a sectioned view of an exemplary storage portion having an exemplary motor for automating the retraction and extension of the panel, in accordance with an embodiment of the present invention. In the present invention, the storage portion may be hidden above a ceiling region 600 in the vehicle. A slit 602 in the ceiling region aligns with the storage portion to enable at least partial passage of the panel during retraction and extension. In some embodiments, the storage portion may include a cylinder disposed to receive the first end of the panel. The cylinder may be configured to rotate in a first direction for retracting the panel, and rotate in a second direction for extending the panel. A motor 604 may power the storage portion. The motor may include various power sources, including, without limitation, an electrical motor powered by the battery from the vehicle, an independent battery, and a solar panel. At least one motor mount 606 may fasten the motor in the storage portion.

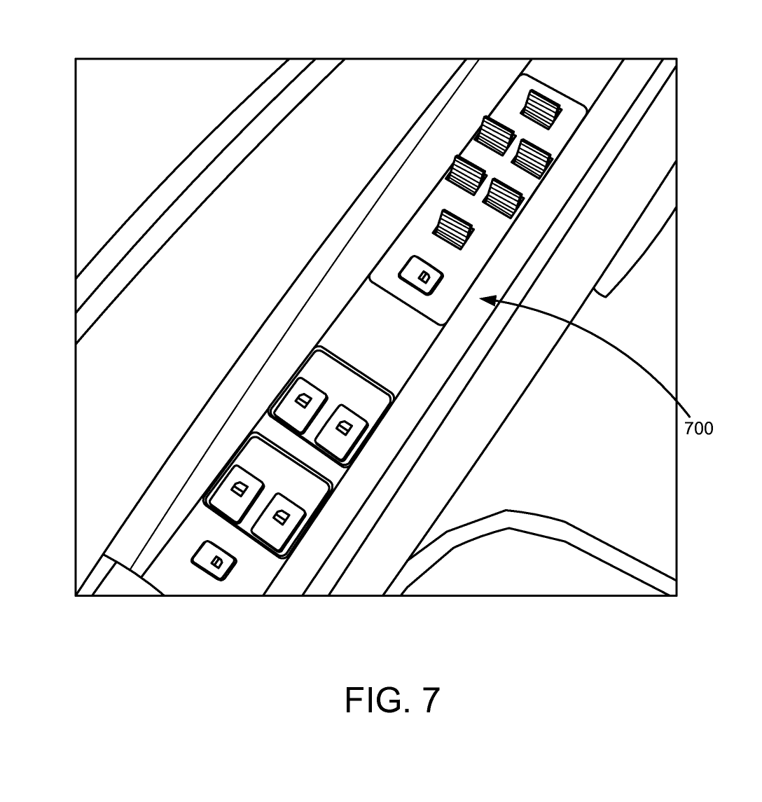

FIG. 7 illustrates a detailed perspective view of an exemplary control portion for controlling the retraction and extension of the panel from an interior region of the vehicle, in accordance with an embodiment of the present invention. In the present invention, a control portion 700 may control the motor for regulating the panel at each window. The control portion may include a plurality of buttons within access of a vehicle operator, whereby each button operates a panel for the respective window. A wire circuitry operatively connects the control portion with the motor in the storage portion.

In one alternative embodiment, the barrier apparatus can be used in residential and business windows. In another alternative embodiment, the telescoping rod is a tensioned string that extends between the track and the panel. In yet another alternative embodiment, the panel can selectively allow different amounts of light to pass through. In another alternative embodiment, the apparatus is powered by solar energy gathered through the window, whereby the panel has external solar cells.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a barrier apparatus for providing shading against a window according to the present invention will be apparent to those skilled in the art. Various aspects of the invention have been described above by way of illustration, and the specific embodiments disclosed are not intended to limit the invention to the particular forms disclosed. The particular implementation of the barrier apparatus for providing shading against a window may vary depending upon the particular context or application. By way of example, and not limitation, the barrier apparatus for providing shading against a window described in the foregoing were principally directed to automated panels that extend and retract from a ceiling on a vehicle to provide shade in a vehicle implementations; however, similar techniques may instead be applied to tints in a vehicle window that can be extended and retracted, depending on the desired look for the vehicle, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus comprising:
a panel configured to at least partially form a barrier, said panel comprising a first end, said panel further comprising a second end, said second end comprising a tapered portion, said panel further comprising a pair of lateral ends;
a storage portion disposed to join with said first end of said panel, said storage portion configured to extend and retract said panel;
a track disposed to extend in at least partial alignment with said pair of lateral ends of said panel; and
a telescoping rod disposed to join said panel with said track, said telescoping rod configured to adjustably increase and decrease in length in coordination with the extension and retraction of said panel.

2. The apparatus of claim 1, wherein said apparatus is disposed to integrate into a vehicle interior region.

3. The apparatus of claim 2, wherein said apparatus is configured to be operable with at least one window from said vehicle.

4. The apparatus of claim 3, in which said panel comprises a mesh composition.

5. The apparatus of claim 4, wherein said panel at least partially forms a barrier to sunlight.

6. The apparatus of claim 5, wherein said storage portion is disposed to position behind a ceiling region.

7. The apparatus of claim 6, in which said ceiling region comprises a slit configured to enable passage of said panel.

8. The apparatus of claim 7, in which said tapered portion comprises a generally tear drop shape.

9. The apparatus of claim 8, wherein said tapered portion is configured to restrict passage of said second end through said slit.

10. The apparatus of claim 9, in which said tapered portion comprises a cavity configured to receive said panel end of said telescoping rod.

11. The apparatus of claim 10, in which said storage portion comprises a cylinder configured to receive said panel and rotatably roll in and out said panel.

12. The apparatus of claim 11, in which said storage portion comprises a motor configured to power said storage portion for extending and retracting said panel.

13. The apparatus of claim 12, in which said motor comprises at least one motor mount configured to at least partially fasten said motor to said storage portion.

14. The apparatus of claim 13, in which said telescoping end comprises a track end disposed to join with said track.

15. The apparatus of claim 14, wherein said track is disposed to at least partially follow along a trim of said vehicle.

16. The apparatus of claim 15, in which said track comprises a channel.

17. The apparatus of claim 16, in which said track end comprises a roller configured to traverse through said channel.

18. The apparatus of claim 17, in which said apparatus comprises a control portion configured to control said storage portion for extending and retracting said panel.

19. An apparatus comprising:
means for positioning a barrier apparatus adjacently to at least one window;
means for positioning a storage portion behind a ceiling region in a vehicle;
means for joining a panel with a track through a telescoping rod;
means for powering a storage portion for extending and retracting said panel;
means for extending said panel for at least partially forming a barrier over said at least one window;
means for guiding said panel along said track;
means for shading said at least one window;
means for retracting said panel; and
means for restricting passage of a second end of said panel through a slit in said ceiling region.

20. An apparatus consisting of:
a panel configured to at least partially form a barrier, said panel comprising a mesh composition configured to at least partially restrict passage of light, said panel comprising a first end, said panel further comprising a second end, said second end comprising a tapered portion, said tapered portion at least partially comprising a cavity, said panel further comprising a pair of lateral ends;
a storage portion disposed to join with said first end of said panel, said storage portion comprising a generally cylindrical shape, said storage portion further comprising a motor, said storage portion further comprising at least one motor mount, said storage portion configured to extend and retract said panel;
a track disposed to extend in at least partial alignment with said pair of lateral ends of said panel, said track comprising a channel;
a telescoping rod disposed to join said panel with said track, said telescoping rod configured to adjustably increase and decrease in length in coordination with the extension and retraction of said panel, said telescoping rod comprising a track end configured to engage said track while extending and retracting, said track end comprising a roller configured to roll in said channel; and
a control portion configured to control said motor.
